(19) United States
(12) Patent Application Publication
(10) Pub. No.: US 2010/0162857 A1
(43) Pub. Date: Jul. 1, 2010

(54) Wrench

(76) Inventor: Chuck CHANG, Taichung City (TW)

Correspondence Address: Dr. BANGER SHIA;Patent Office of Bang Shia, 102 Lindencrest Ct., Sugar Land, TX, 77479-5201, US

(21) Appl. No.: 12/344,513

(22) Filed: Dec. 27, 2008

(51) Int. Cl. B25B 13/46

(52) U.S. Cl. 81/63.1

(57) ABSTRACT

A wrench comprises a drive head, a drive element and at least two same-structured pawls. The drive element is disposed in a drive portion on an inner surface of the drive head and defined with at least two recesses. The at least two pawls are respectively pivoted in the at least two recesses by pivot pin. Between the recesses is disposed a reversing element, which is provided with an elastic element and a push element opposite the respective pawls in such a manner that the push element can push against the pawls. The pawl is provided with two engaging ends opposite two opposite ends of the drive portion of the drive head. The two engaging ends of each of the pawls are not symmetrical to each other and configured to engage with the drive portion. The pawls in the respective recesses are disposed in the same direction or different directions.

### BACKGROUND OF THE INVENTION

1. Field of the Invention

The present invention relates to a wrench, and more particularly to a wrench which is provided with at least two same-structured pawls on a drive element which is provided on an inner surface of a drive head to achieve the micro-angle drive and common angle drive objectives, reduce the cost and improve the practicality of the overall structure.

2. Description of the Prior Art

Conventional wrench structures can be divided into reversing and non-reversing types according to interior configuration of the wrench drive head. In addition, the reversing wrenches can also be divided into two types: one is that the reversing device is separated from the drive element in the drive head, and the other is that the reversing device is integral with the drive element in the drive head. The wrench in which the reversing device is integral with the drive element is for example the wrench 10 as shown in FIGS. 1-2. The drive head 11 of the wrench 10 is provided with a tooth-shaped drive portion 110 on an inner surface thereof, and the drive portion 110 is provided with a drive element 20 on an inner surface thereof. In the drive element 20 is further provided a reversing element 31 of a reversing device 30. A pawl 40 is pivoted to each of two opposite sides of the drive element 20 by pivot pin, and each of the two pawls 40 is provided with two opposite tooth-shaped engaging ends 41 for cooperating with the tooth-shaped drive portion 110 of the drive head 11. The tooth-shaped engaging ends 41 of each of the pawls 40 are symmetrical, have the same pitch and don't have any position difference therebetween, so that when the engaging ends 41 of the pawls 40 of the drive element 20 are operated, one engaging end 41 of the respective two pawls 40 will be engaged with the drive portion 110 of the drive head 11 synchronously. Presently, since the drive angle is limited by the teeth of the drive portion 110 of the drive head, such a synchronous engaging structure generally has 24 teeth, i.e. the skip drive angle of the drive element 20 is about 15 degrees. The skip drive angle is quite large, so that the wrench 10 cannot be applied in narrow space.

The above wrench structure is similar to the structure disclosed in U.S. Pat. No. 6,205,891, but the pawls in U.S. Pat. No. 6,205,891 each are formed with a toothed engaging end opposite to the periphery of drive portion, and a single engaging end design enables the two pawls to engage to the drive portion of the drive head synchronously, so that it also suffers from the above disadvantages: the skip drive angle is quite large, non-applicable in narrow space.

Further, Taiwan Patent No. 404879 discloses two pawls that are not synchronous engaged. The tooth configurations of each of the two pawls are designed to be in a symmetrical form as shown in FIG. 2, and the engaging ends at two ends of each of the pawls 40 are symmetrical to each other, but the tooth configurations of the engaging ends 41 of the two pawls 40 of the same drive element 20 are designed to have different position differences, so that when one of the engaging ends of one of the pawls 40 is engaged into the drive portion of the wrench drive head, the engaging ends of the other of the pawls 40 will not be engaged to the drive portion of wrench drive head. Therefore, the two pawls have different tooth configurations. Although such a wrench is applicable in narrow space due to the functions such as non-synchronous engagement, micro-angle swaying and skip engagement, the two pawls must be produced respectively due to different structured pawls, thus increasing the cost. Furthermore, if the two pawls are designed to have different position differences between their tooth configurations, the wrench which employs such two pawls can have the function of micro-angle engagement only, namely when in use, only one of the engaging ends of a single pawl will be engaged into the drive portion of the drive head, thus producing a limited engaging force, which cannot satisfy the requirement of large torque.

Further referring to U.S. Pat. No. 6,457,386, the wrench comprises two engaged pawls that are both disposed in the same groove, and the two pawls have the same tooth configuration, as for such a wrench, the two pawls can be engaged to each other synchronously to realize the synchronous drive objective, but it is difficult to offer the function of micro-angle engagement drive.

The present invention has arisen to mitigate and/or obviate the afore-described disadvantages.

### SUMMARY OF THE INVENTION

The primary objective of the present invention is to provide a wrench with the same pawls each of which has a position difference between two engaging ends thereof, wherein the drive element in the drive head is provided with two opposite pawls characterized in that the two pawls each include two tooth-shaped engaging ends, and the two engaging ends of the same pawl are not symmetrical to each other, namely the two engaging ends of the same pawl are designed to have a position difference smaller than a pitch of the tooth-shaped drive portion. The two pawls on the drive element are disposed in the opposite directions to form a micro-angle drive wrench. Since the pawls are the same structured, the production cost is relatively reduced.

The second objective of the present invention is to a wrench with the same pawls each of which has a position difference between two engaging ends thereof, wherein the pawls on the drive element in the drive head each have two tooth-shaped engaging ends which have a position difference therebetween and thus are nonsymmetrical to each other, the position difference between the two engaging ends of the same pawl is designed to be smaller than a pitch of the drive portion, and the two pawls are disposed in the same direction, namely the pawls extend the same structured engaging ends to engage with the drive portion, so that the pawls can be engaged to the drive portion to form a common angle drive configuration, which can offer a large torque.

### BRIEF DESCRIPTION OF THE DRAWINGS

FIG. 1 is a cross-sectional view of a conventional wrench;

FIG. 2 is a top view of a pawl of the conventional wrench;

FIG. 3 is an exploded perspective view of a wrench in accordance with the present invention;

FIG. 4 is a top view of the wrench in accordance with the present invention;

FIG. 5 is a top view of a pawl of the wrench in accordance with the present invention; and

FIG. 6 is a top view of the wrench in accordance with the present invention where the two pawls are disposed differently from that shown in FIG. 4.

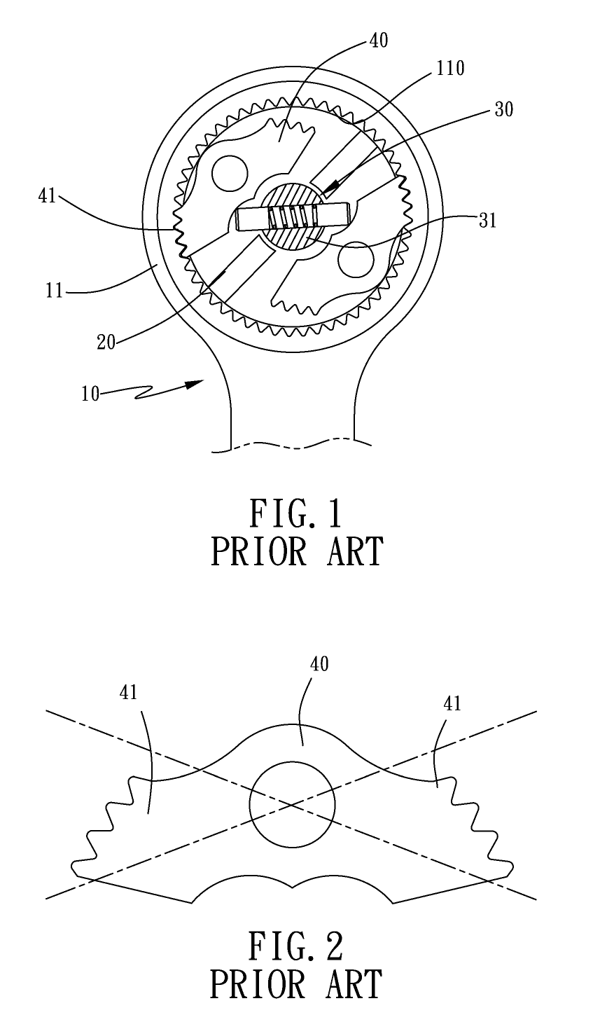

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

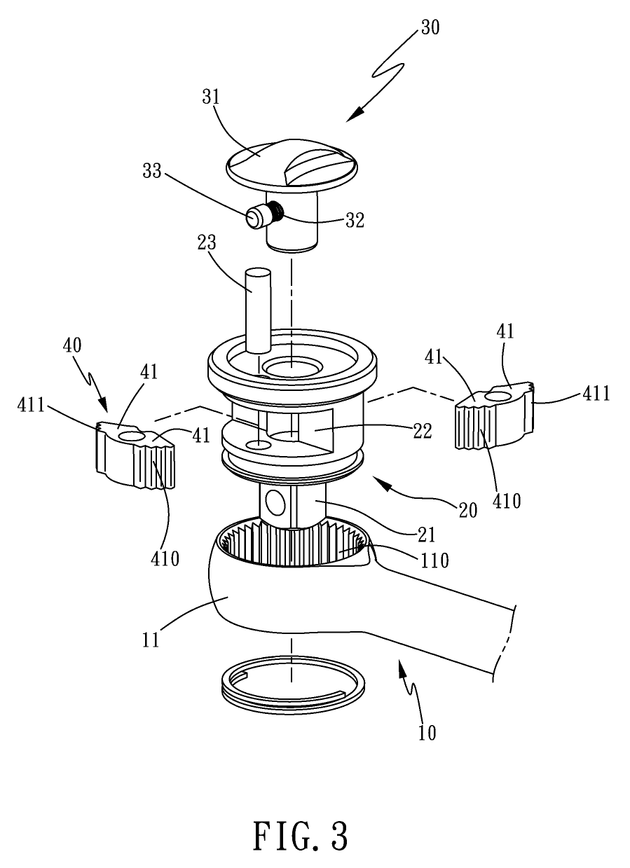

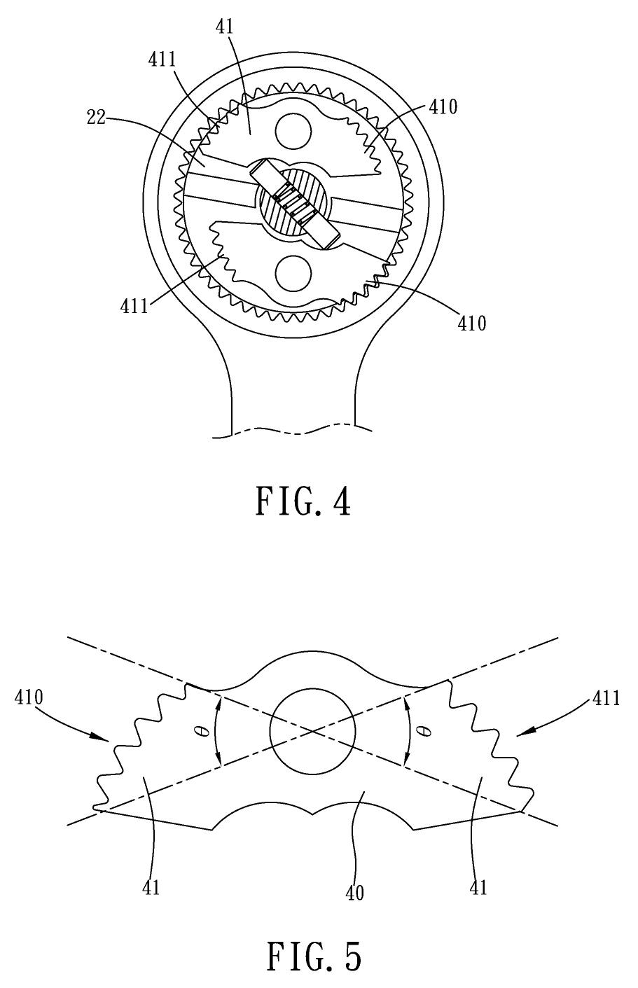

Referring to FIGS. 3-4, a wrench 10 in accordance with the present invention comprises a drive head 11 and a drive element 20. The drive head 11 is hollow and includes a continuous equally-divided tooth-shaped drive portion 110 on an inner surface thereof. The drive element 20 is disposed on an inner surface of the drive portion 110 and combined in the drive portion 110 by a C-shaped or other forms of clip. The drive element 20 has a smaller diameter end in the form of a square column that extends out of the drive portion 110 to cooperate with a steel ball to form a drive end 21. The drive element 20 is provided with a reversing device 30 in the bigger diameter end thereof, which is located in the drive portion 110. The bigger diameter end of the drive element 20 is defined with a recess 22 in each of two opposite sides thereof. Each of the recesses 22 is pivoted with a pawl 40 by a pivot pin 23. The reversing device 30 essentially includes a reversing element 31 whose center is inserted into the drive element 20, and at least one elastic element 32 opposite the respective pawls 41. Each of the elastic elements 32 is provided with a bullet-shaped push element 33 at one end thereof for pushing against the opposite pawl 41. Due to the rotation of the reversing element 31, the push element 33 will be driven to push against the opposite ends of the respective pawls 40 at different angles in such a manner that the respective pawls 40 can extend different ends thereof outside the drive element 20 to drivingly engage with the drive portion 110.

The pivot pins 23 penetrate through the middle portion of the respective pawls 40. The push elements 33 are pushed by the elastic elements 32 to push the back surfaces of the respective pawls 40. Each of the pawls 40 is formed with two engaging ends 41 opposite two ends of the drive portion 110 of the drive head 11. The respective engaging ends 41 are provided with a first mating portion 410 and a second mating portion 411 to mate with the drive portion 110. The present invention is characterized in that:

The first and second tooth-shaped mating portions 410, 411 at the two engaging ends 41 of the pawl 40 are designed in such a manner that the first mating portion 410 and the second mating portion 411 at the two engaging ends 41 of each of the pawls 40 have a position difference smaller than a pitch of the drive portion 110. Referring to FIGS. 3-4 together with FIG. 5, between two extending lines from the center of the pivot pin 23 is defined an angle θ, the first mating portion 410 and the second mating portion 411 are disposed between the two tangent points of the extending lines and the periphery of the respective engaging ends 41, and the first mating portion 410 and the second mating portion 411 are not symmetrical to each other, namely, the first mating portion 410 starts from a tooth crown and ends at a tooth root, and the second mating portion 411 doesn't start from a tooth crown, and for example in the present embodiment, the second mating portion 411 starts from a tooth root and ends at a tooth crown, so that there is a position difference smaller than the pitch between the first mating portion 410 and the second mating portion 411 at the two engaging ends 41 of the pawl 40. With such arrangements, the same pawls 40 can be disposed into the two recesses 22 in different directions or the same direction, thus relatively reducing the production cost of the pawl 40, and the pawls 40 can be assembled in different directions according to the requirements of different torques.

When the same structured pawls 40 are disposed in different directions in the recesses 22, even if the two pawls 40 are synchronously pushed by the push elements 33 of the elastic elements 32 of the reversing element 31 of the reversing device 30 to extend the engaging ends 41 outside the drive element 20 to engage with the drive portion 110, one of the pawls 40 will extend its first mating portion 410 outside the drive element 20 to engage with the drive portion 110 while the other of the pawls 40 will extend its second mating portion 411 outside the drive element 20 to engage with the drive portion 110. By such arrangements, after the drive head 11 drives the drive element 20 to move, the first mating portion 410 of one of the pawls 40 will engage with the drive portion 110, and the second mating portion 411 of the other of the pawls 40 will not engage with the drive portion 110, and when the drive head 11 starts rotating backwards about an angle of half tooth of the drive portion 110, the second mating portion 411 which is not in an engagement with the drive portion 110 originally will be brought into a driving engagement with the drive portion 110, so that the drive engagement of the drive head 11 and the drive element 20 can be realized as long as the drive portion 110 is rotated backwards the angle of half tooth, thus forming a micro-angle drive wrench.

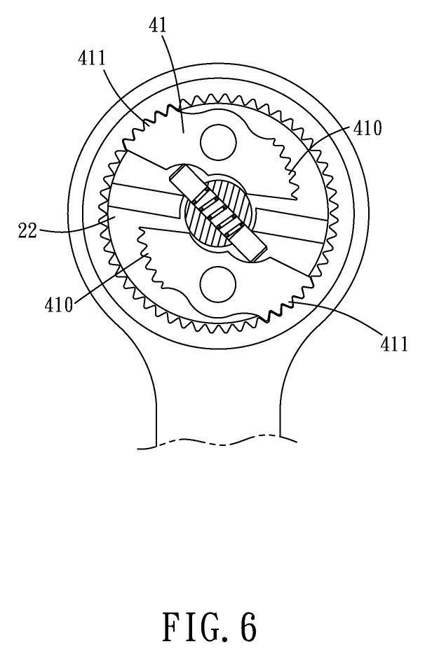

When the two same structured pawls 40 in the two recesses 22 of the drive element 20 are disposed in the same direction as shown in FIG. 6, even if the two pawls 40 are pushed by the push elements 33 which are pushed by the elastic elements 32 on the reversing element 31 of the reversing device 30 to extend the respective engaging ends 41 outside the drive element 20 to engage with the drive portion 110, one of the pawls 40 will extend its first mating portion 410 outside the drive element 20 to engage with the drive portion 110, and the other of the pawls 40 will also extend its first mating portion 410 outside the drive element 20 to engage with the drive portion 110, otherwise one of the pawls 40 extends its second mating portion 411 outside the drive element 20 to engage with the drive portion 110, and the other of the pawls 40 will also extend its second mating portion 411 outside the drive element 20 to engage with the drive portion 110. By such arrangements, the two pawls 40 will synchronously extend the same mating portions to engage with the drive portion 110, and the rotation angle of the drive head 11 must be two times as large as that in the embodiment shown in FIG. 4, so the torque produced by the present embodiment is also twice as large as the torque produced by the previous embodiment, thus satisfying the requirements of large torque. Further, since the tooth configuration on the inner surface of the drive portion 110 of the drive head 11 of the present invention are completely unaltered and capable of directly bearing a larger torque, and the engaging ends 41 of the respective pawls 40 are not symmetrical, the same structured pawls 40 can be disposed in the different directions or the same direction to perform the micro-angle and common angle drive operation of the wrench of the present invention and can further produce a larger torque.

As known from a further analysis of the above-mentioned, the mating portions at two engaging ends 41 of the respective pawls 40 are not symmetrical, namely there is a position difference smaller than a pitch of the drive portion 110 between the two mating portions of the same pawl 40. Although the first mating portion 410 and the second mating portion 411 are configured to engage with the drive portion, due to the position difference between the first mating portion 410 and the second mating portion 411 of the same pawl 40, two same structured pawls 40 can be disposed in the two recesses 22 of the drive element 20 in the same direction or different directions to realize the objectives of micro-angle drive and large torque output. As for the micro-angle drive structure, such a design can greatly reduce the production cost, and as for the wrench 10 which requires outputting a larger torque without micro-angle drive, two pawls 60 of the same structure can be disposed as shown in FIG. 6 to synchronously extend the same structured mating portions outside the drive element 20 to drivingly engage with the drive portion 110 to form a structure capable of outputting a larger torque.

While we have shown and described various embodiments in accordance with the present invention, it is clear to those skilled in the art that further embodiments may be made without departing from the scope of the present invention.

What is claimed is:

1. A wrench comprising:
a drive head being formed with a continuous tooth-shaped drive portion on an inner surface thereof;
a drive element being disposed in the drive portion and formed with a smaller diameter drive end extending out of the drive portion, a bigger diameter end of the drive element being defined with at least two recesses; and
at least two pawls disposed in the respective recesses, each of the pawls being formed with two engaging ends opposite to two opposite ends of the drive portion of the drive head, and the two engaging ends of each of the pawls are respectively formed with a first mating portion and a second mating portion to mate with the drive portion, there is a position difference smaller than a pitch of the drive portion between the first mating portion and the second mating portion of the two engaging ends of each of the pawls;
the pawls in the respective recesses are the same structures disposed in the same direction and opposite directions.

2. The wrench as claimed in claim 1, wherein the big diameter end of the drive element is further provided with a reversing device, which essentially includes a reversing element, a center of the reversing element is inserted into the drive element, and the reversing element is provided with at least one elastic element opposite the respective pawls, and the elastic element is provided with a push element on an end thereof for pushing against the respective pawls.

3. The wrench as claimed in claim 1, wherein a pivot pin is provided in each of the recesses and penetrates a middle portion of each of the pawls, and each of the pawls is provided with a first mating portion and a second mating portion respectively on two engaging ends thereof for matting with drive portion of the drive head, between two extending lines from a center of each of the pivot pins is defined an angle, the first mating portion and the second mating portion of each of the pawls are disposed between two tangent points of the extending lines and a periphery of the respective engaging ends of the each of the pawls, and the first mating portion and the second mating portion of the respective pawls are not symmetrical to each other, namely the first mating portion starts from a tooth crown and ends at a tooth root while the second mating portion doesn't start from a tooth crown.

4. The wrench as claimed in claim 3, wherein the second mating portion starts from a tooth root and ends at a tooth crown.

5. The wrench as claimed in claim 1, wherein the pawl in one of the recesses extends its first mating portion outside the drive element to engage with the drive portion, and the paw in the other of the recesses extends its second mating portion outside the drive element to engage with the drive portion, thus forming a micro-angle drive structure.

6. The wrench as claimed in claim 1, wherein the pawl in one of the recesses extends its first mating portion outside the drive element to engage with the drive portion while the paw in the other of the recesses also extend its first mating portion outside the drive element to engage with the drive portion, and similarly if the pawl in one of the recesses extends its second mating portion outside the drive element to engage with the drive portion, the pawl in the other of the recesses will also extend its second mating portion outside the drive element to engage with the drive portion.
